(19) United States
(12) Patent Application Publication
(10) Pub. No.: US 2005/0078628 A1
(43) Pub. Date: Apr. 14, 2005

(54) Base station transmitting data spread with a plurality of slots respective to a plurality of radio terminals and codes, and a cellular system thereof

(75) Inventors: Toshiro Suzuki, Tama (JP); Satoshi Takahashi, Yokohama (JP); Junichi Nakagawa, Tokorozawa (JP); Ken Takei, Kawasaki (JP)

Correspondence Address: SOFER & HAROUN, L.L.P., Suite 910, 317 Madison Avenue, New York, NY, 10017, US

(73) Assignee: Hitachi, Ltd

(21) Appl. No.: 10/968,377

(22) Filed: Oct. 18, 2004

Related U.S. Application Data
(62) Division of application No. 09/853,127, filed on May 10, 2001.

(30) Foreign Application Priority Data
Aug. 8, 2000 (JP) 2000-245522

(51) Int. Cl. H04J 1/10

(52) U.S. Cl. 370/328; 455/561

(57) ABSTRACT

A radio base station, comprising: a time slot preparing unit for preparing a time slot to be transmitted to a radio terminal; a selecting unit for selecting a modulation system and a coding method of the time slot prepared by the preparing unit; a signal processing unit for modulating and coding the time slot prepared by the preparing unit according to the modulation system and the coding method, which are selected by the selecting unit; an amplifying unit for amplifying a slot modulated and coded by the signal processing unit; a controlling unit for controlling the amplifying unit to amplify a transmitting power of a specified priority slot among the plurality of time slots so as to be larger than that of a non-priority slot; and an antenna unit for transmitting the time slot amplified by the amplifying unit.

### RELATED APPLICATIONS

This application is a divisional application of U.S. patent application Ser. No. 09/853,127, filed on May 10, 2001, which in turn claims the benefit of priority from Japanese Patent Application No. 2000-245522, filed on Aug. 8, 2000, the entirety of which are incorporated herein by reference.

### BACKGROUND OF THE INVENTION

The present invention relates to a cellular system adopting a time division multiplex system in a part or the whole of a circuit. More particularly, the invention relates to a speeding-up technology of a transmitting speed in the vicinity of a cell boundary.

In a time division multiple access (TDMA) system, a radio base station has divided one frame into a plurality of time slots, and has allotted the plurality of slots obtained by the division to the respective terminals in a cell, thus enabling multiple access. In this case, a frequency for use in one cell is common in all of the terminals.

Meanwhile, in a cellular system, mutually different frequencies in cells adjacent to each other have been used in order to prevent radio wave interference.

Incidentally, a code division multiplex access (CDMA) system is known as a method of preventing the radio wave interference. In a cellular system adopting this CDMA system, a diffusion code is used, thus enabling all of the cells to commonly use the frequency.

In order to enable high-speed data communication, a high data rate (HDR) system combining the CDMA and the time division multiplex in a down circuit from a radio base station to a terminal is examined for developing a radio packet communication technology.

Generally, in the CDMA system, even if a plurality of signals are simultaneously added and transmitted, it is possible to sort the signals at a receiver side by modulating the same by a code orthogonal to the respective channels. This multiplexing system can be realized by modulating the signals by an orthogonal code having a rate sufficiently higher than a speed of information desired to be transmitted. In other words, the speed of information capable of being transmitted must be sufficiently lower than the speed of the orthogonal code. However, in the HDR system, the speed of information is desired to be increased nearly to the speed of orthogonal code in order to increase the speed of information capable of being transmitted. Therefore, for multiplexing the signals, as shown in FIG. 2, a system generally called time division multiplex is used, in which each channel is divided into time slots obtained by dividing the channel in terms of time and the time slots are sent out.

A problem possibly occurring in this case is interference caused between cells adjacent to each other. This interference may cause the lowering of the transmitting speed.

### SUMMARY OF THE INVENTION

In order to prevent the foregoing problems, in the present invention, slot arrangement and a receiving power at a terminal for each slot are determined in consideration of an environment in the vicinity of a cell boundary.

The present invention is a cellular system having a plurality of radio base stations communicable with radio terminals by radio, wherein, in a cell boundary serving as a communication area which the plurality of radio base stations constitute, each radio base station constituting the cell boundary selects a slot different from the other, and this selected slot is transmitted with a transmitting power larger than that of the other slot transmitting by the radio base station itself.

Moreover, the present invention is a radio base station of a radio communication system, wherein the radio base station is communicable with a radio terminal by radio, and transmits data to a plurality of radio terminals accommodated in the radio base station itself, respectively. The data transmitted to the plurality of radio terminals are diffused by diffusion codes different from one to another, thus transmitting specified data to the radio terminal serving as a communication destination. The diffused data is stored in a plurality of slots corresponding to the plurality of terminals, and is transmitted to the radio terminal. In this case, among the plurality of slots, a slot different from that of the other radio have station adjacent thereto is selected as an object slot, and this object slot is transmitted with a transmitting power larger than that of the other slot transmitted by the radio base station itself.

In a radio base station of the radio communication system, a time slot preparing unit for preparing a time slot to be transmitted to a radio terminal is provided. Then, by a selecting unit, a plurality of modulation systems and a plurality of coding methods are selected for the plurality of time slots prepared by the preparing unit. A signal processing unit individually modulates and codes the plurality of time slots prepared by the preparing unit according to the modulation system and the coding method, which are selected by the selecting unit. In an amplifying unit, the slots modulated and coded by the signal processing unit are amplified. A controlling unit controls the amplifying unit to amplify a transmitting power of a specified priority slot among the plurality of time slots so as to be larger than that of a non-priority slot. Then, an antenna unit transmits the time slot amplified by the amplifying unit.

### BRIEF DESCRIPTION OF THE DRAWINGS

For a more complete understanding of the present invention and the advantages thereof, reference is now made to the following description taken in conjunction with the accompanying drawings.

FIG. 1 is a diagram and a table showing a basic concept of HDR.

FIG. 2 is a diagram showing a constitution of a time slot of HDR.

FIG. 3 is a view and a diagram showing an example of use for a slot of a HDR system.

FIG. 4 is diagrams showing some examples of a terminal receiving power and interference in the vicinity of a cell boundary.

FIG. 5 is a view and a diagram showing slot arrangement and transmitting power.

FIG. 6 is a diagram showing slot arrangement and transmitting power of the present invention.

FIG. 7 is a view showing a constitution example of a radio base station.

FIG. 8 is a view showing another constitution example of the radio base station.

FIG. 9 is a diagram showing a relation among a priority slot, a non-priority slot and a transmitting power.

FIG. 10 is a view showing still another constitution example of the radio base station.

### DESCRIPTION OF THE PREFERRED EMBODIMENT

Description will be made for an example of a radio system using a time division multiplex system and a variable modulation system by the use of an HDR system that is described from page 73 to page 75 in Nikkei Communication No. 311 (issued on Feb. 7, 2000, by Nikkei Business Publications, Inc.).

The HDR system is a cellular radio communication system aiming high speeding of a data transfer rate without changing a basic parameter from a cdma 2000 1× system as a public standard. In order to realize this high speeding, a radio base station is ceased to be commonly used for both voice and data, but is exclusively used for data, and optimization thereof is achieved. Unlike voice communication, data communication does not require a strict real time characteristic, and the speed of data transfer is not always required to be constant, either.

In general, in the cellular radio system, a transmitting environment varies depending on a traffic request in a service area, various noises or the like. However, the HDR system improves its statistical throughput as a best effort type system by limiting exclusively its use to data transfer.

Classification will be made below for features of the radio system for use in HDR.

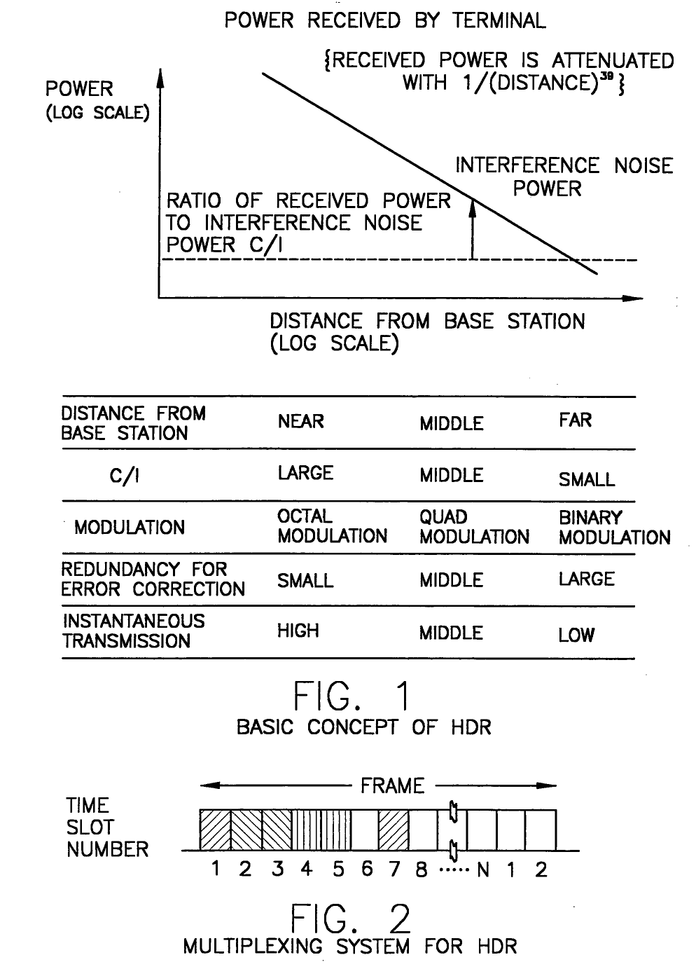

(1) Variable modulation system: In general, a radio wave is intense in the vicinity of a radio base station, and an intensity of the radio wave is being attenuated as the wave travels far therefrom. FIG. 1 shows a state thereof. Since C/I representing a ratio of the intensity of radio wave and an interference noise is high when the intensity of radio wave is high, it is possible to increase a quantity of information capable of being transmitted for a unit time by allowing the modulation of the radio wave to be multi-valued. Moreover, since the noises are low, it is possible to realize highly efficient data transmission by lowering coding redundancy required for error correction.

On the contrary, in a location far from the radio base station, the number of values in the modulation system is reduced to reduce errors while demodulating, and the coding redundancy for error correction is increased, thus achieving an improvement of a correction capability.

(2) Time division multiplex: Generally, in the CDMA system such as cdma 2000, even if a plurality of signals are simultaneously multiplexed and transmitted, it is possible to demultiplex the signals at a receiver side by modulating the respective channels by a code orthogonal. This multiplexing system can be realized by modulating the signals by an orthogonal code having a rate sufficiently higher than a speed of information desired to be transmitted. In other words, the speed of information capable of being transmitted must be sufficiently lower than the speed of the orthogonal code.

However, in the HDR system, the speed of information is desired to be increased nearly to the speed of the orthogonal code in order to increase the speed of information capable of being transmitted. Therefore, for multiplexing the signals, as shown in FIG. 2, a system generally called time division multiplex is used, in which each channel is divided into time slots obtained by dividing the channel in terms of time and the is sent out.

At this time, the modulation system of each slot is optimally set depending on a terminal to be contacted, moreover, the number of slots to be occupied by each channel is also determined by a requested transmitting rate.

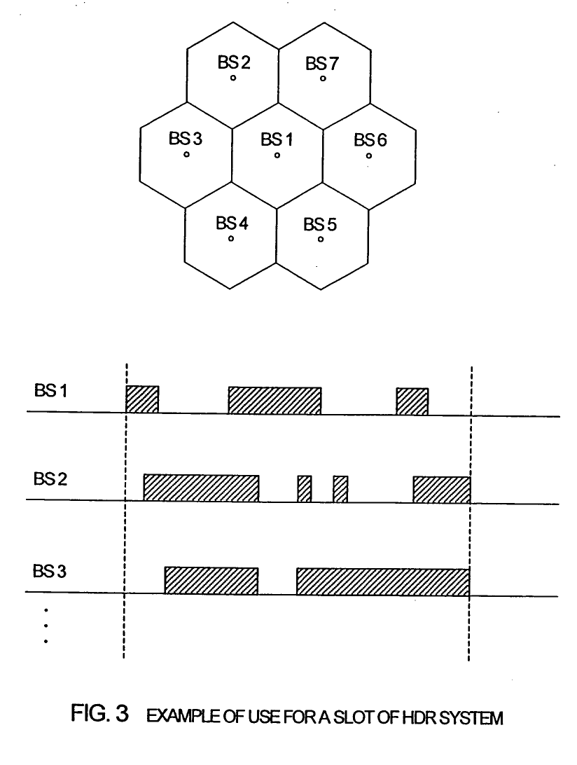

(3) Handover: FIG. 3 shows an example of a state where the time slot is used under the presence of a plurality of radio base stations. As shown in the drawing, each radio station performs communication by the use of each time slot at best effort in accordance with a request from a terminal present in each cell. However, since allotment of the time slots is independently set by means of the state of each radio base station in the HDR system, the_states where the time slot is used are completely different among the respective cells.

In general, the handover of the CDMA system is referred to as soft handover, in which a handover originating cell and a handover destination cell simultaneously use one channel and signals of the both cells are synthesized to be used. This soft handover is enabled only when the signals are subjected to code multiplexing in the respective radio base stations. When the time division multiplexing as shown in the drawing is performed, typical soft handover cannot be realized.

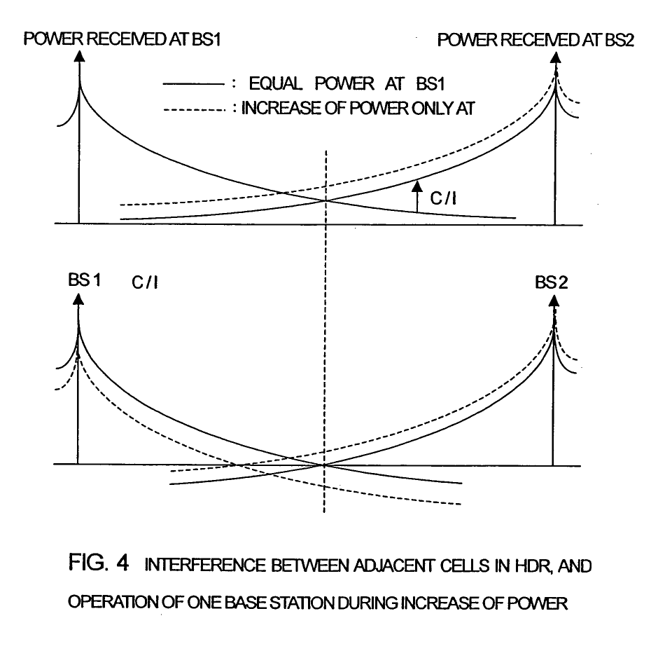

(4) Interference between adjacent cells: FIG. 4 shows a state where signals sent out from two radio base stations attenuate at a middle position therebetween. Generally, in an urban area, the sent-out radio wave signals attenuate in proportion to the −3.5th power of a distance from the radio base station. Herein, on the assumption that two radio base stations BS1 and BS2 transmit signals having equal powers, signals from the both radio base stations reach the same level exactly at the middle point between the both radio base stations. This means that amplitudes of the signal and the interference noise become equal, specifically, C/I becomes 0 dB when seen from one radio base station.

In order to increase the transmitting speed, a value of this C/I is required to be large (for example, 3 to 10 dB), and at the point where this C/I becomes 0 dB, high-speed transmission cannot be realized.

Herein, if a power of BS2 is increased by, for example, 10 dB, C/I for the signal of BS2 at this middle point becomes 10 dB, thus enabling a desired high-speed transmission to be realized. On the other hand, when seen from the signal of BS1, C/I is lowered to −10 dB, and the transmitting speed is extremely lowered.

Accordingly, if only the power of any radio base station is increased in an attempt to increase the transmitting speed at the middle point (hereinafter referred to as “cell fringe”) of the both radio base stations, there occurs a problem that the transmitting speed of the terminal connected to an adjacent cell is lowered.

Next, description will be made for an improving method of performance of a radio communication system consisting of a radio base station and terminals, particularly for an improving method of a transmitting speed and a controlling method of Quality of Service (QoS) in a system using time division multiplexing (TDM) and variable modulation.

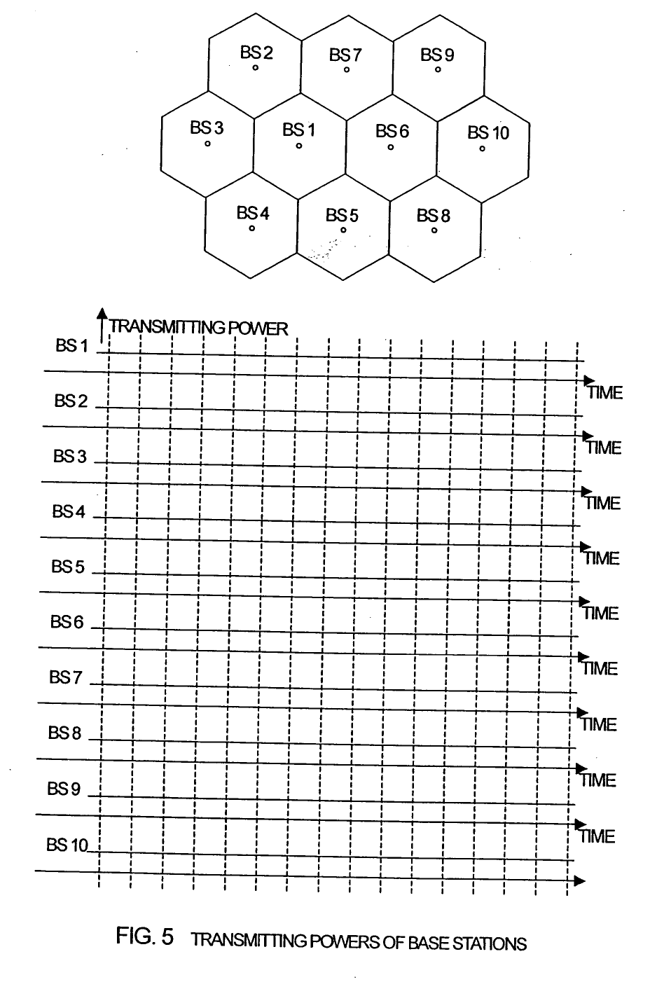

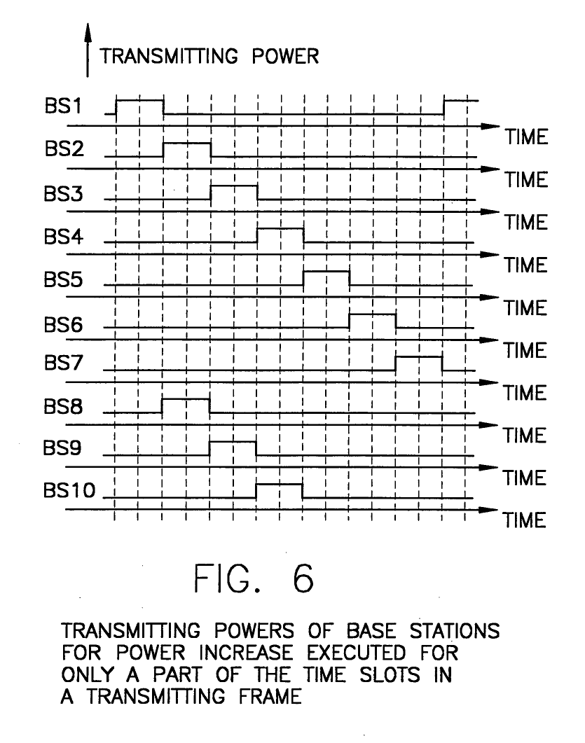

First, fundamental technical concept of this embodiment will be described. FIG. 5 shows transmitting powers of the respective radio base stations when the transmitting power from the concerned radio base station is increased over all of the time slots in order to improve C/I by means of increase of the electric power or the like. As shown in FIG. 5, if the transmitting powers are constant in all of the time slots, jamming to the other cells adjacent in various directions cannot be avoided. However, if this power increase is executed only for a part of the time slots in a transmitting frame as shown in FIG. 6, the jamming to the adjacent cells is limited in terms of time. Accordingly, if this slot, in which the power is increased, is differently provided by each radio base station, it is possible to provide both of the slots: slots jammed to each other; and slots capable of improving C/I of its own signals. Accordingly, if arrangement is performed, in which the slots improving C/I at least in the adjacent cells do not abut against each other, the high-speed transmission is enabled even in the vicinity of the middle point between radio base stations so far as the concerned slot is used.

Next, a concrete embodiment will be described.

FIG. 6 shows an example of transmission signals from the respective radio base stations to which the present invention is embodied. First, arrangement itself of a plurality of radio base stations is similar to the arrangement shown in FIG. 5. And, there is shown an example of a non-overlap system of a 7-cell repeating type, where each radio base station has an antenna pattern of an omni-cell shape. However, for example in the case where each radio base station is of a 3-sector type, it is possible to alternatively employ a non-overlap system of a 4-cell repeating type or the like. This non-overlap system has the same concept as that of a frequency reuse system of an already well known FDMA system. As shown in FIG. 6, it is possible to arrange the time slot of each cell, in which the power is increased, at least so as not to be the same as that of the adjacent cell.

Hereinafter, this slot, in which the power is increased, will be referred to as a “priority slot” or an “object slot”. Moreover, other slots will be referred to as a “non-priority slot”.

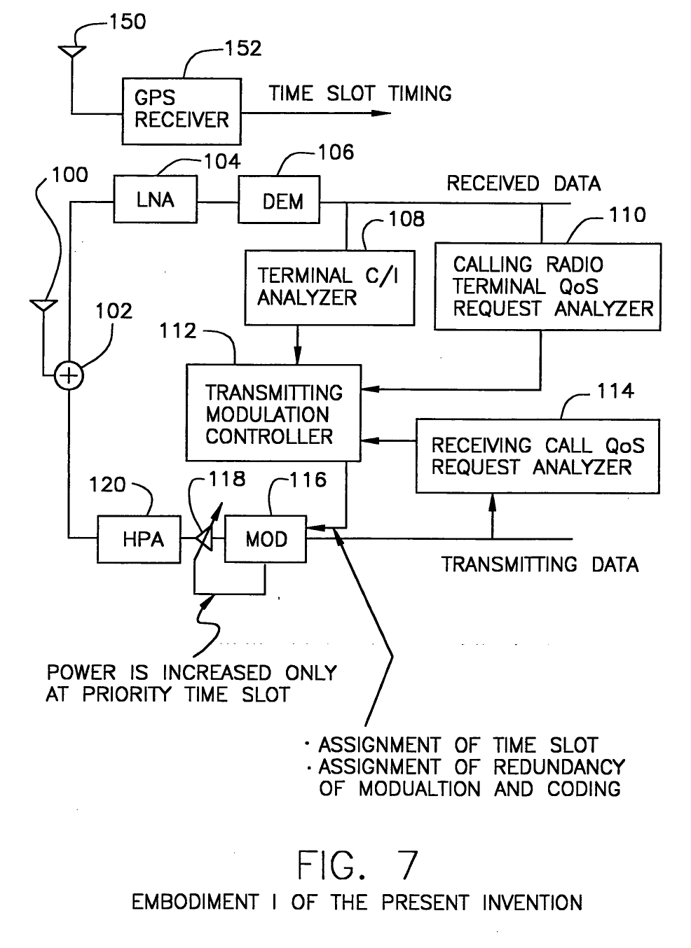

FIG. 7 shows one embodiment of the radio base station realizing the priority slot. A radio wave from a terminal received by a radio antenna (100) is sent to a low noise amplifier LNA (104) by an antenna sharer (102), and is amplified there.

The amplified radio wave is demodulated into a digital signal by a demodulator DEM (106), and received data thereof is sent to a C/I analyzer (108) and a calling radio terminal QoS request analyzer (110).

C/I at the terminal, which is included in the received data, is extracted by the C/I analyzer (108), and the result thereof is sent to a transmitting modulation controller (112).

Meanwhile, a calling QoS request value included in the received data is extracted by the calling radio terminal QoS request analyzer (110), and the result thereof is sent to the transmitting modulation controller (112). On the other hand, transmitting data is sent to a receiving call QoS request analyzer (114) and a modulator MOD (116). A receiving call QoS request value included in the transmitting data is extracted in the receiving call QoS request analyzer (114), and the result thereof is sent to the transmitting modulation controller (112).

The transmitting modulation controller (112) determines a time slot, a modulation system and redundancy for error correction from C/I at the terminal, the calling QoS request value and the receiving call QoS request value, and sends the result thereof to the MOD (116). The MOD (116) modulates the transmitting data in accordance with the determined time slot and the modulation system and a coding system, and sends the result thereof to a power controller (118).

Moreover, the MOD (116) determines the priority time slot based on a system time of the radio base station, and informs the power controller (118) with priority time slot information.

The priority time slot of the BS1 in the 7-cell repeating constitution in FIG. 6 is allotted by the MOD (116), for example, when a function f(t)=mod{(t−t0)/τ, 14} is 0 or 1, where an absolute starting time of the system is t0, a slot width is τ, and a current time is t. Herein, a function mod (A, B) represents a remainder obtained by dividing A by B.

Similarly to the above, the priority time slot to the BS2 is allotted when f(t) is 2 or 3; the priority time slot to the BS3 is allotted when f(t) is 4 or 5; the priority time slot to the BS4 is allotted when f(t) is 6 or 7; the priority time slot to the BS5 is allotted when f(t) is 8 or 9; the priority time slot to the BS6 is allotted when f(t) is 10 or 11; and the priority time slot to the BS7 is allotted when f(t) is 12 or 13, respectively.

The power controller (118) increases the power only for the priority time slot by a certain fixed value α [dB] (C/I increasing value required to increase the transmitting speed, for example, 3 dB to 10 dB).

The output from the power controller (118) is amplified to a power required for communication by a power amplifier HPA (120), sent to the radio antenna (100) by the antenna sharer (102), and transmitted to the terminal. Moreover, a radio wave from a GPS satellite is received by a GPS antenna (150), the absolute time is extracted by a GPS receiver (152), and the system of the radio base station is determined.

Description will be made for a more detailed operation of the transmitting modulation controller (112) by the use of the example of BS1 of FIG. 6. In this example, BS1 has two priority time slots.

By the C/I value in the terminal by the system, a usable modulation system M and redundancy R for error correction are uniquely fixed by, for example, a function m(₀), r(₀), where M=m(C/I), R=r(C/I). Herein, the function m(₀), r(₀) is represented, for example, as in the following formulas.

$$\begin{matrix}M = m ( C / I ) \{ \begin{matrix}2 ( BPSK ) & C / I < 0 dB \\ 4 ( QPSK ) & 0 dB ≦ C / I < 3 dB \\ 16 ( 16 QAM ) & 3 dB ≦ C / I\end{matrix} & \\ R = r ( C / I ) \{ \begin{matrix}1 / 4 & C / I < 4 dB \\ 1 / 3 & 4 dB ≦ C / I < 8 dB \\ 1 / 2 & 8 dB ≦ C / I\end{matrix} & [ Formula 2 ]\end{matrix}$$

Furthermore, with regard to the calling QoS request value and the receiving call QoS request value for each user, these values are put in order for example, from a larger value of the sum thereof, the priority time slots are allotted only for two users requesting larger values, and the time slots other than the priority time slot are allotted for the other users. Herein, any one of the calling QoS request value and the receiving call QoS request value may be put in order similarly to the above-described manner, and the priority time slots may be allotted for the two users requesting larger values. Moreover, in each radio base station, the number of time slots capable of being allotted as the priority slots and the number of users for which the priority time slots are allotted correspond to each other. Accordingly, for a radio base station having users requesting higher QoS, a larger number of time slots may be allotted as the priority slots in accordance with the number of such users. In this case, as a matter of course, the number of priority slots capable of being allotted for the adjacent radio base station is limited. For the above-described two users in which the priority time slots are allotted, C/I is improved by the power increase value α [dB]. Therefore, a modulation system M′ and coding redundancy R′ for each of the users are given, for example, by a function M′=m(C/I+α), R′=r (C/I+α).

When QoS requested by the concerned terminal is high, that is, when high-speed transmission is requested, the MOD transmits a signal directed to this terminal in the priority time slot and increases the transmitting power to a certain value, thus enabling a high transmitting rate to be realized.

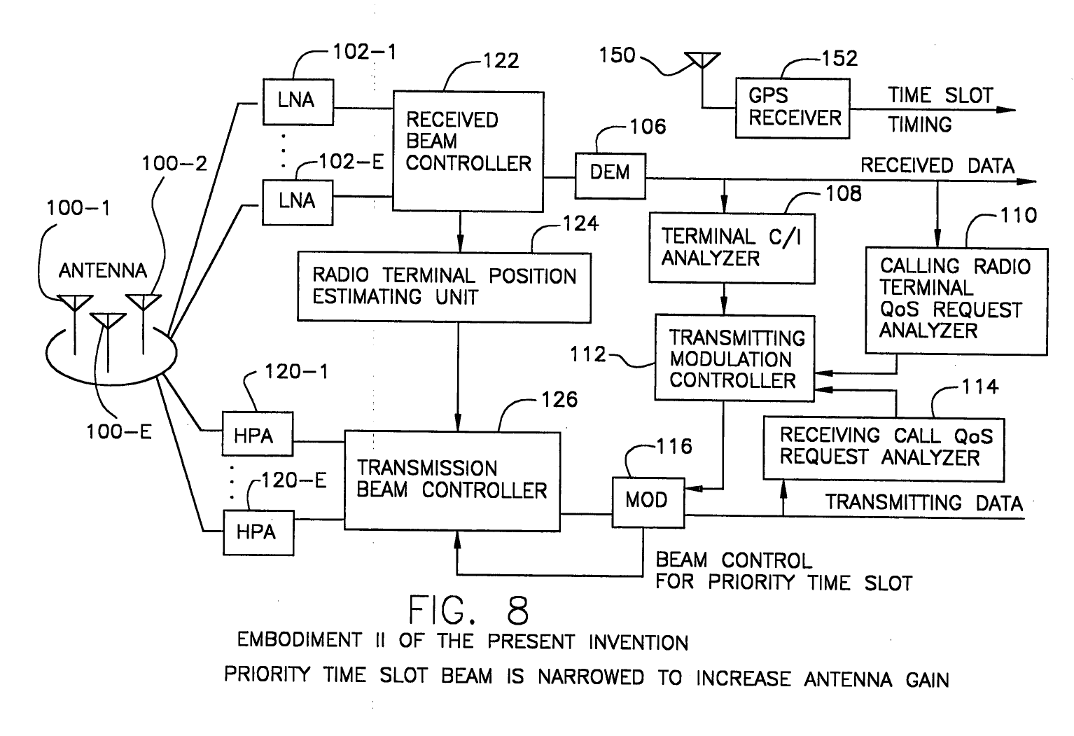

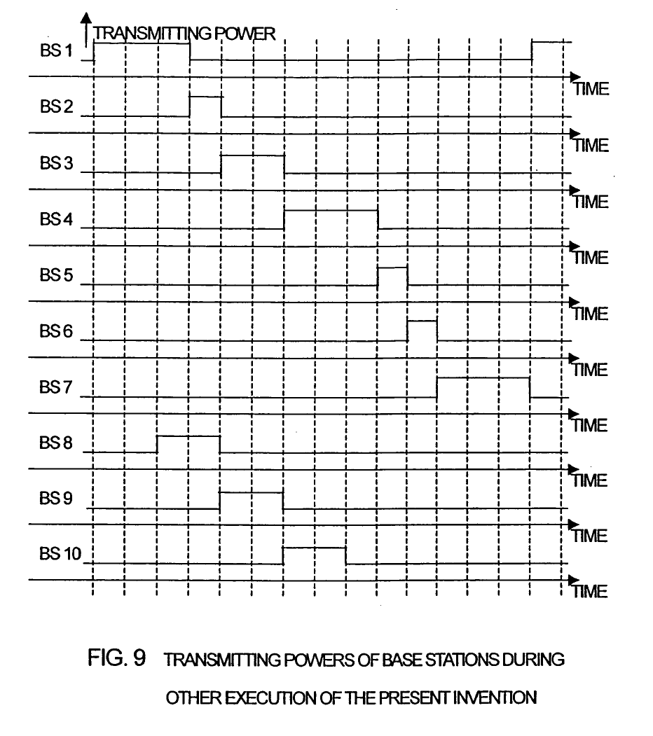

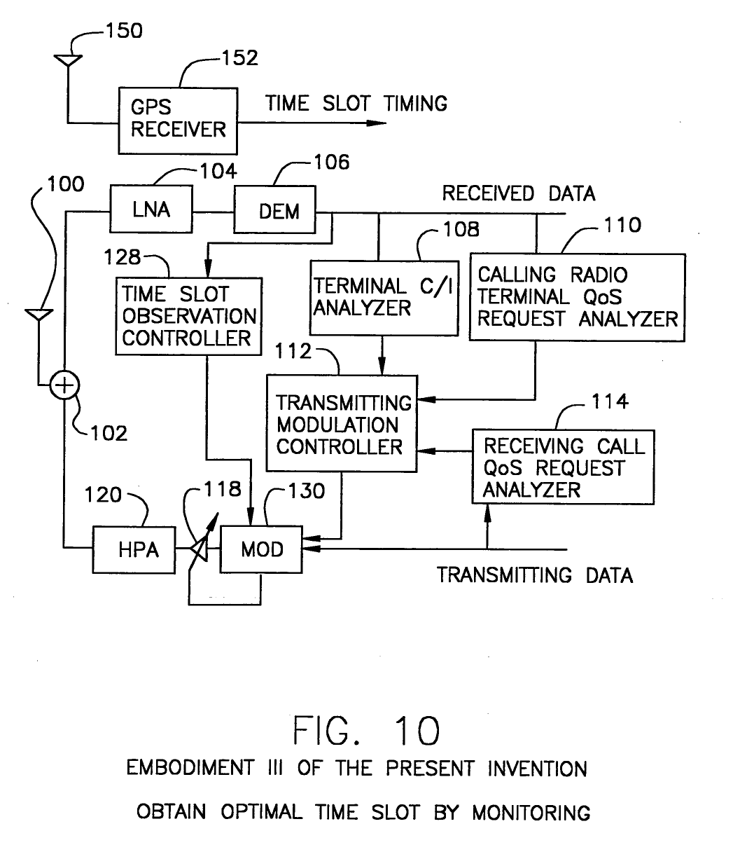

In the above example, description has been made for the case where the power is increased in the priority time slot. In an example shown in FIG. 8, in place of the increase of transmitting power, a gain of a transmitting antenna is increased by constituting the transmitting antenna as an array antenna and stopping expansion of a transmitted beam, thus increasing C/I at the receiving point equivalently.

Similarly to the example of FIG. 7, this band narrowing of the antenna beam is executed in the priority time slot. In FIG. 8, a radio wave from a terminal, which is received by array antennas (100-1, 100-2, . . . , 100-E; E stands for the number of elements of the array antennas), is amplified by corresponding LNAs (104-1, 104-2, . . . , 104-E), thus limiting the direction where the radio wave from the terminal comes.

At this time, the received radio waves are given to the DEM (106), and weight information concerning the beam control and received radio wave intensity information are given to a radio terminal position estimating unit (124), respectively. The weight information and the received radio wave intensity information are observed while scanning the direction where the received radio wave comes, and thus the radio terminal position estimating unit (124) estimates a position of the terminal. A result of this estimation is given to a transmission beam controller (126).

Meanwhile, the radio wave given to the DEM (106) of the terminal, which is seen from the concerned radio base station, is demodulated. And as described in the first embodiment described above, the modulation output and the priority time slot information are determined by the C/I analyzer (108), the calling radio terminal QoS request analyzer (110), the transmitting modulation controller (112), the receiving call QoS request analyzer (114) and the MOD (116). Thereafter, the modulation output and the priority time slot information are respectively given to the transmission beam controller (126). In the transmission beam controller (126), according to the terminal position and the priority time slot information, the beam width is varied by changing the weight information concerning the beam control.

For example, while even weight distribution is given to the non-priority time slot to form a wide beam, Taylor weight distribution known in that the power is concentrated thereby is given to the priority time slot to form a beam concentrated on the terminal position.

Each beam output is amplified to a power require for communication in the HPAs (120-1, . . . , 120-E), and transmitted by the antennas (100-1, 100-2, . . . , 100-E).

As usage of this priority time slot, the following is conceived.

(1) When QoS requested from the terminal is high and a receiving state of the terminal is not good, and (2) when there does not occur traffic to an extent where the entire time slots are used in any radio base station, by sequential use of the time slots from the priority time slot, local multiplexing by time division, which is executed among the respective radio base stations, is realized.

The width of the priority time slot should be basically equal among the respective radio base stations. When an area in which the traffic is particularly concentrated and an area in which it is not concentrated very much are adjacent to each other, as shown in an example of transmission signals from the respective radio base stations to which the present invention is executed, the width of the priority time slot can be made wider in the radio base station located in the area in which the traffic is concentrated than in the peripheral radio base station. At this time, the width of the priority time slot in the peripheral radio base station is reduced as a matter of course.

If it is possible to grasp a time slot being used in the peripheral radio base stations, it will be possible to maintain the traffic capability of the whole system to be high, by setting a priority order so that the concerned radio base station may not use the same time slot as possible.

It is also possible to optimize the allotment of time slot for each frame by always observing the time slots used by the peripheral radio base stations. FIG. 10 shows an embodiment where the optimal slot allotment is performed for each frame. This embodiment is different from the above-described example in that a time slot observation controller (128) for determining a priority time slot for a base radio station of its own is added between the DEM (106) output and the MOD (130).

The time slot observation controller (128) holds, for example, a receiving power in the time slots for the past two frames. Then, in the case where the peripheral radio base station does not use two frames consecutively, and for example, the sum of the calling QoS and the receiving call QoS exceeds a predetermined threshold value, the time slot observation controller (128) functions so that the MOD (130) can instruct the radio base station of its own to use the priority time slot.

Moreover, in the embodiments described above, the radio base station always increases the transmitting power in the priority time slot. However, it is not always necessary to increase the transmitting power. When C/I of the user, which is accommodated in the priority slot, is sufficiently high, for example, 3 dB or more, it is also possible not to increase the transmitting power in the priority time slot. In this case, since the interference to the user using the peripheral radio base station can be reduced, reduction of the entire throughput can be restricted to a minimum.

Furthermore, in the former embodiments, description has been made for the example where the radio base station determines the priority time slot independently. However, a constitution is also enabled, in which a central control station controlling the respective radio base stations is provided to determine the priority time slot according to a request from the radio base stations. By providing the central control station in the above-described manner, intensive administration of frequency sources is enabled, the interference among all of the radio base stations can be reduced, and the entire throughput can be improved.

Still further, in each radio base station, it is also possible to determine the width of the priority time slot independently by random numbers limited to integer times of the slot width. According to this method, though the entire throughput is reduced due to the increase of the interference, effects brought by the present invention can be obtained by a simple constitution.

Note that description has been made in this text for the effect of the power control according to the present invention by the example of increasing the transmitting powers of the respective radio base stations. However, since C/I is determined by a ratio of these transmitting powers, it is needless to say that the present invention can be achieved also by dropping the transmitting powers of the radio base stations other than that using the priority time slot.

Note that the technical concept of the present invention is applicable not only to HDR but also to the other communication systems.

In the present invention, in order to avoid the lowering of the transmitting speed in the cell fringe, the transmitting powers at the radio base stations connected to each other are increased, alternatively the antenna gain is increased by the use of the array type antenna or the like, thus improving C/I at the concerned point. Moreover, at this time, the interference such as the lowering of the speed is reduced for the terminal connected to the adjacent cell.

Although the preferred embodiment of the present invention has been described in detail, it should be understood that various changes, substitutions and alternations can be made therein without departing from spirit and scope of the inventions as defined by the appended claims.

10. A radio base station, comprising:
a time slot preparing unit for preparing a time slot to be transmitted to a radio terminal;
a selecting unit for selecting a modulation system and a coding method of the time slot prepared by the preparing unit;
a signal processing unit for modulating and coding the time slot prepared by the preparing unit according to the modulation system and the coding method selected by the selecting unit;
an amplifying unit for amplifying the slot modulated and coded by the signal processing unit;
a controlling unit for controlling the amplifying unit to amplify a transmitting power of a specified priority slot among the plurality of time slots so as to be larger than that of a non-priority slot; and
an antenna unit for transmitting the time slot amplified by the amplifying unit.

12. The radio base station according to claim 10, further comprising a determining unit for determining the priority slot in order that transmission timing of the priority slot can be different from that of a priority slot of the other radio base station located in the direction where the priority slot is transmitted.
